(19) United States
(12) Patent Application Publication
(10) Pub. No.: US 2004/0137265 A1
(43) Pub. Date: Jul. 15, 2004

(54) Light emitting apparatus

(76) Inventors: Junichi Shimada, Kyoto-shi (JP); Yoichi Kawakami, Kusatsu-shi (JP); Shigeo Fujita, Kyoto-shi (JP); Yasuchika Hasegawa, Toyonaka-shi (JP); Shozo Yanagida, Kawanishi-shi (JP); Yuji Wada, Toyonaka-shi (JP)

Correspondence Address: Oliff & Berridge, P O Box 19928, Alexandria, VA, 22320, US

(21) Appl. No.: 10/476,456

(22) PCT Filed: May 1, 2002
(86) PCT No.: PCT/JP02/04349

(30) Foreign Application Priority Data
May 2, 2001 (JP) 2001-135116

(51) Int. Cl. H05B 33/00

(52) U.S. Cl. 428/690; 428/917; 313/504; 257/80; 257/88; 257/102; 257/103

(57) ABSTRACT

According to the present invention, first, a white LED with high color rendering property is realized. In addition, a general object of the present invention is to provide a highly practical light emitting device wherein a rare earth complex is utilized as a wavelength conversion light emitting device of a high efficiency. Such an object is achieved by providing a combined light emitting device wherein a specific complex having a rare earth ion, particularly an Eu (europium) ion, as the central ion, is borne by a transparent solid matrix such as polymer or plastic, and this rare earth complex is excited by an InGaN based blue light emitting diode or by a semiconductor laser utilizing a light emitting layer of InGaN based material. A combination of such a blue light emitting diode, a YAG yellow fluorescent material and such an Eu complex for red light allows for the formation of a white light source with high color rendering property. In addition, a combination of such a semiconductor laser and a plastic containing such a rare earth complex can be widely utilized for automobile parts and the like, as an illuminant which is compact and light in weight and has a long life.

### TECHNICAL FIND

The present invention relates to a light emitting device which combines a wavelength conversion substance including an organic fluorescent material made of rare earth complex, and a light emitting diode or a semiconductor laser which excites the wavelength conversion substance.

### BACKGROUND ART

A feature of a light emitting diode (LED) is that it has a high monochromaticity (that is, the width of half maximum of the spectrum peak is narrow). Using such a feature, fill color display devices have already been widely used, where red (R), green (G) and blue (B) LED illuminants are arrayed two-dimensionally on a plane. In the devices, the display color is arbitrarily controlled with the intensity ratio of the RGB colors.

However, when it is considered as an illumination device rather than a display device, many problems still remain to be solved with an LED. White light can be obtained using a device including an array of LED illuminants of RGB, and setting the intensity ratio of RGB appropriately. As an illumination device, however, there are some problems including those listed as follows with an LED compared to conventional illumination devices such as incandescent lamps or fluorescent lights: (1) the size of the device is generally large; (2) respective colors of RGB must be controlled independently; and (3) the device has a poor “color rendering property”.

Herein, “color rendering property” is the property of a light source concerning how an object exhibits its color when the object is illuminated by the light source. Considering the importance of the color rendering properties of illumination devices, the CIE (Commision Internationale de l'Eclairage) has determined an evaluation method for the color rendering property in 1964. According to this method, a series of reference light sources are determined where the reference light sources are selected depending on the color temperature of the light source to be evaluated. The color rendering index Ra is determined from the difference in the color of a predetermined test color between the case when it is illuminated by the reference light sources and in the case when illuminated by the light source to be evaluated. Color rendering index Ra takes a value between 0 and 100, wherein at the value of 100, the light source to be evaluated exhibits the same colors as the reference light sources. As the reference light source, a full radiator, or a Planckian radiator, is used when the color temperature is equal to or less than 5000 K, and calculated values of the daylight spectrum (which is referred to as a “synthesized daylight”) are used when the color temperature exceeds 5000 K. For the test color, eight colors having a predetermined spectral reflectance are selected for general purposes. The color rendering index calculated based on them is called a general color rendering index. In addition to those, seven colors are selected for special purposes, where the skin color of Japanese people is included. The color rendering index calculated based on these colors is called a special color rendering index. For further details, “Illumination Engineering” (edited by the Japan Electric Society and published by Ohm Corporation, pp. 36-) can be referred to.

Light of a full radiator is used as a reference in evaluating color rendering properties because the natural light (sunlight) is close to light of the full radiator. Light emitted from a full radiator includes light of various wavelengths in a continuous manner. The hue of an object is determined by the light reflectance (spectral reflectance) of the object at each wavelength. Thus, the color of an object when it is illuminated by light including lights of various wavelengths continuously and its intensity distribution is close to that of the full radiator is close to the color when illuminated by natural light But an LED white light illuminant composed of RGB does not have a continuous spectrum but rather has a discontinuous spectrum having narrow peaks only at the three wavelengths of R (red), G (green) and B (blue), even though it emits white light by adjusting the intensity ratio of the respective colors. Due to the discontinuity, ROB-LED illuminants cannot exhibit a color rendering property necessary for an illumination device.

As a white light illumination light source composed of a single LED, one using a gallium-nitride based blue LED covered with (or applied with) a YAG phosphor has been devised (c.f. the Japanese Unexamined Patent Publication No. 5-152609 (1993)). In this light source, the YAG phosphor is excited by the blue light (wavelength: 460 mm) from the InGaN active layer of the gallium-nitride based blue LED, so that white light is obtained as a mixture of the yellow light, which is the fluorescent light emitted from the YAG phosphor, and the blue light from the LED.

FIG. 1 shows the spectrum of a white LED (correlated color temperature: 6500 K) composed of a gallium-nitride based blue LED to which a YAG phosphor is applied, and the spectrum of a standard light D₆₅ (correlated color temperature: 6504 K). The standard light D₆₅ is a standard light for the evaluation of the color rendering index and represents the daylight of color temperature 6504 K, which is determined by the CIE through statistical processing of actually measured values of the natural daylight sp distribution. The spectral distribution of the white LED in the violet to blue-violet region, in the blue-green to green region and in the red region are low compared to that of the standard light D₆₅. FIG. 2 shows the color rendering indexes of a white LED, which shows that the special color rendering indexes at blue-violet, green and red are low corresponding to the above spectral distribution. Accordingly, in some application fields, it is necessary to strengthen necessary spectral components to enhance the color rendering property of an object.

An example in the field of medical application is described. A surgical operation (internal shunt providing operation on a patient suffering from chronic renal failure) was successfully carried out for the first time in the world using a white light LED illumination device in Kyoto Prefectural Yosanoumi Hospital on Sep. 11, 2000. The illumination device is manufactured by mounting light emitting panels on a plastic goggle, where each light emitting panel includes an array of white LED chips composed of gallium-nitride based blue LEDs applied with YAG phosphors. The operation was carried out with a sufficient illuminance powered by a battery, and proved the usefulness of white LEDs as a handy illumination device wearable on a surgeon.

At the time of the operation, however, it was pointed out concerning the color rendering properties of white LEDs that it was difficult to distinguish for example, arteries (vivid red) from veins (dark red). It occurred because the white LEDs had a problem with the color rendering properties in the red region. The problem can be solved by strengthening the spectrum component at the reddish orange region of 597-640 mm, and in the red region of 640-780 nm.

In order to strengthen the spectrum component of the red region, first it is possible to distribute AlGaInP based LEDs or AlGaAs based LEDs two-dimensionally in a white LED chip. However, it is necessary to place chips as closely and uniformly as possible, and to place a diffusion board on the surface of the LED light emitting panel in order to uniformly mix the spectrum of the emitted light in the irradiated plane. In addition to that, the intensity of white LEDs (gallium-nitride based blue LEDs applied with YAG-phosphor) and that of red LEDs (AlGaInP based LEDs, or AlGaAs based LEDs) must be independently controlled.

The simplest method of strengthening the spectrum of the red region without causing above-described problem is to apply fluorescent material that emits light in the red region to currently used white LEDs. However, when widely used general illumination devices are targeted, the red fluorescent material should have a high efficiency and high stability. In addition to that, it is important to have a good workability, to be free from components poisonous to human body, and to be free from such substances that pollutes the earth's environment when dumped.

By using organic molecular materials, such as rhodamine, as the fluorescent material in the red region, it is possible to obtain a high luminous efficiency. But they easily decompose and degrade when irradiated by light, so that they are not appropriate for practical uses. ZnCdS:Ag based and Y₂O₂S:Eu³⁺ based fluorescent materials are used as the red light phosphor (excited by electron beams) in a cathode ray tube of a TV set, and provide comparatively high conversion efficiency to the red color with an LED light source of the ultraviolet region (360-380 nm). However, they do not provide sufficient conversion efficiency when excited by blue light, so that it is inappropriate to use them with currently used white LEDs (gallium-nitride based blue LEDs applied with YAG-phosphor). Considering the fact that the luminous efficiency of the currently available ultra-violet LEDs is significantly low compared to that of blue LEDs, combination of those fluorescent materials with the currently available ultra-violet LED is also not practical,. Further, the fluorescent materials are stable for a long period of time only when contained in a sealed vacuum cathode ray tube. When they are used in the atmosphere, however, they absorb moisture and photochemical reactions are accelerated, which result in a deterioration of the fluorescent materials. Sealing technology for preventing such a problem has not yet been developed. Furthermore, ZnCdS:Ag based material includes Cd, which may give rise to an apprehension in its deleterious effect on the environment.

As discussed above, red fluorescent materials that have been developed so far to be used in combination with current white LEDs have problems.

Conventionally, a variety of fluorescent materials have been developed by adding rare earth metals such as Eu (europium), Th (terbium) and Tm (thulium) to inorganic oxides and inorganic sulfides. Conventionally, based on the energy gap theory of the quantum physics, it was believed that “rare earth metal is hard to emit light in an organic medium”. Actually the luminous efficiency of rare earth metals in organic media, such as in a plastic, was very low until recently.

Notwithstanding that, some of the present inventors reconsidered the energy gap theory and successfully designed a group of complexes of rare earth metals such as neodymium that can emit light in organic media for the first time in the world in 1995 (“How can neodymium that does not glow in organic media be made to glow?”, by Yasuchika Hasegawa, Chemistry and Industry, Volume 53(2000) No. 2, pp. 126-130). Some patent applications were also filed (PCT/JP98/00970=WO98/40388, Japanese Unexamined Patent Application No. 10-238973 (1998)=Japanese Unexamined Patent Publication No. 2000-63682, Japanese Unexamined Patent Application No. 11-62298 (1999)=Japanese Unexamined Patent Publication No. 2000-256251).

These complexes are stable even at a temperature as high as 350° C., and hardly deteriorate when irradiated by light, which turns over the conventional knowledge that organic compounds easily deteriorate due to heat or light irradiation. In addition, these complexes have a high affinity with resin based host materials such as plastics and polymers, and are also easily worked. Thus they are expected to be a light element of the next generation.

In order to implement a white LED having an excellent color rendering property as described above, the present invention selected materials particularly suitable for the purpose among the above complexes, and employed them to implement a white LED for illumination purposes with excellent color rendering property. It is made of a light emitting diode or a semiconductor laser having an InGaN based light emitting layer covered with organic metal complex containing a rare earth ion, with a nano-sized host-guest composite containing such metal complex, or with transparent polymer including such organic metal complex or nano-sized host-guest composite.

The present invention is not limited to the above range. The present inventors noticed the fact that the wavelength range of the excitation light for the above rare earth complexes is very narrow, so that these complexes can be used for a high efficiency wavelength conversion light emitting device. That is, the inventors have come up with the idea that the above rare earth complexes are combined with a light emitting diode with the emitting wavelength range as narrow as the above excitation light, or combined with a semiconductor laser which has an extremely narrow emitting wavelength. The combination as a result males a light emitting device with a very high luminous efficiency and with a high luminance. Moreover, the light emitting diode and the semiconductor laser are very compact, and the rare earth complexes have a good affinity with plastics and polymers; therefore, the inventors have come up with the idea that a variety of compact and lightweight light emitting devices with a long life can be provided in a wide range of practical application

### DISCLOSURE OF THE INVENTION

Accordingly, a light emitting device according to the present invention has a basic construction characterized in that a transparent solid matrix including one or more substances selected from a group of rare earth complexes having the following structural formulas is combined with a light emitting diode or a semiconductor laser that emits an excitation light corresponding to the f-f transition of the central ions of these complexes,

general formula (I):

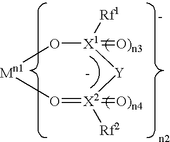

(wherein M represents a rare earth atom; n1 represents 2 or 3; n2 represents 2, 3 or 4; Rf¹ and Rf² are the same or different and represent an aliphatic substituent of C₁ to C₂₂ including no hydrogen atom, an aromatic substituent including no hydrogen atom or a heterocyclic substituent including no hydrogen atom; X¹ and x² are the same or different and represent any atom of the group IVA elements, the group VA elements except nitrogen and the group VIA elements except oxygen; n3 and n4 represent 0 or 1; and Y represents C-Z′ (Z′ represents an aliphatic substituent of C₁ to C₂₂ including no deuterium atom, halogen atom or hydrogen atom), N, P, As, Sb or Bi, provided that n3 is 0 when X¹ is a carbon atom, n4 is 0 when X² is a carbon atom, and at least one of Rf¹ and Rf² is an aromatic substituent including no hydrogen atom when both X¹ and X² are carbon atoms),

general formula (II):

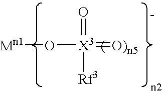

(wherein M, n1 and n2 are as defined in the above; Rf³ represents an aliphatic substituent of C₁ to C₂₂ including no hydrogen atom, an aromatic substituent including no hydrogen atom or a heterocyclic substituent including no hydrogen atom; X³ represents any atom of the group IVA elements except carbon, the group VA elements except nitrogen and the group VIA elements except oxygen; and n5 represents 0 or 1),

general formula (III):

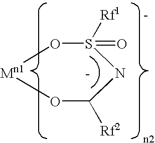

(wherein M, Rf¹, Rf², n1 and n2 are as defined in the above),

general formula (IV):

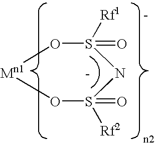

(wherein M, Rf¹, Rf², n1 and n2 are as defined in the above),

genera formula (V):

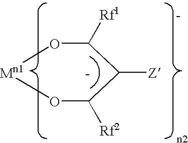

(wherein M, Rf¹, Rf², n1, n2 and Z′ are as defined in the above), and

general formula (VI):

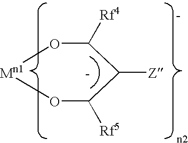

(wherein M, n1 and n2 are as defined in the above; Z″ represents a hydrogen atom or Z′ (Z′ is as described above); and Rf⁴ and Rf⁵ are the same or different and represent an aliphatic substituent of C₁ to C₂₂ including no hydrogen atom, an aromatic substituent including no hydrogen atom or a heterocyclic substituent including no hydrogen atom).

Examples of the aliphatic substituent C₁ to C₂₂ including no hydrogen atom, the aromatic substituent including no hydrogen atom, the heterocyclic substituent including no hydrogen atom, as well as X¹, x² and X³ are described in paragraphs [0031] to [0037] of the Japanese Unexamined Patent Publication No. 2000-63682, where a reference to them is requested. In addition, syntheses of the above complexes are also described in paragraphs [0047] to [0067] of the publication.

Herein, rare earth complexes wherein Rf1 and Rf2 are of C1, C2 or the like, among the above rare earth complexes, have high affinity with plastics and polymers of the transparent solid matrix which will be described later, and in particular CF3 or CF2CF3 produces a stable polymer.

A nitride semiconductor light emitting diode having a light emitting layer represented by a general formula: InₓGai₁₋ₓN(0<x<1), or a semiconductor laser having this, is used as the illuminant for exciting the above rare earth complexes. Excitation light for the f-f transition of various rare earth ions can be generated arbitrarily by changing the component variant x, so that efficient excitation can be carried out on the central ions of the above rare earth complexes.

Transparent resin is most commonly used as the above transparent solid matrix. Resins are very lightweight and have excellent workability, and, therefore, provides a very broad range of applications of the light emitting device according to the present invention. The polymer matrix described in paragraph [0069] of the Japanese Unexamined Patent Publication No. 2000-63682 can be used as the transparent resin In addition, a method for diffusing the above Eu complex into a transparent resin is described in [0070] of the above publication.

For the transparent solid matrix, in addition to the above-described one in which a rare earth complex is directly mixed into transparent resin, one made by the following process can also be used The rare earth complex is first borne on a (host-guest) composite having an average particle size of nanometers, and then the nano-size composite is mixed into a transparent resin. Alternatively, liquid containing the nano-size composite is contained in a transparent container. Various types of the nano-size composite bearing rare earth complexes and their manufacturing methods are described in detail in the Japanese Unexamined Patent Publication No. 2000-256251.

Rare earth complexes are organic complexes having divalent, trivalent or tetravalent ions of rare earth elements as their central ions and including the above-described ligands. In the present invention, the rare earth complexes function as optical materials where the central ions carry out a light excitation and light emission, which will be described later,.

Rare earth elements is the general name of the 17 elements: scandium Sc (atomic number: 21), yttrium Y (atomic number: 39) and lanthanoids (atomic number: 57 to 71, lanthanum La, cerium Ce, presidium Pr, neodymium Nd, promethium Pm, samarium Sm, europium Eu, gadolinium Gd, terbium Th, dysprosium Dy, holmium Ho, erbium Er, thulium Tm, ytterbium Yb, lutetium Lu). Though, in the rare earth elements, compounds having the oxidation number of 3 are generally stable, some oxides of Ce are tetravalent and some oxides of Sm, Eu, Yb are divalent According to the atomic structure, the two elements before Sc and the two elements before Y are main transition elements wherein electrons fill the 3d shell, and 15 lanthanoid elements are inner transition elements wherein electrons fill the 4f shell. The lanthanoids have base electron configurations of (n−2)f^{0 to 14}(n−1)s²(n−1)p⁶(n−1)d^{0 to 2}ns² (n is 6 or 7).

It is known that rare earth elements form a variety of complexes. The energy levels of the transition shells of the rare earth elements are splitted in the complexes so that a variety of energy levels are generated. It was found in the above prior applications that the transition (f-f transition) between the energy levels within the 4f shell can make an optical material useful in practice by appropriately selecting a rare earth element and ligands-around it.

The present invention teaches the excitation means for such optical materials and clarifies specific applications thereof in order to enhance its implementation. That is, the above rare earth complex optical material is used as the wavelength conversion element, and a light emitting diode or a semiconductor laser is used as the input light source. Thus, the above rare earth complex is borne in a transparent solid medium (matrix) in order for the optical material to be used in specific optical elements or optical components.

Light emitted from light emitting diodes has a comparatively narrow wavelength range. On the other hand, excitation occurs exclusively through the f-f transitions of a specific orbital of the complex ion, which is the central ion of the above rare earth complex. Therefore, the excitation wavelength range is extremely narrow (1 nm or less). Accordingly, by adjusting the wavelength of the light emitted from the light emitting diode to the excitation wavelength of the complex, the energy of a light emitting diode is efficiently utilized for the excitation of a complex, and the wavelength is converted so that light having a longer wavelength is emitted. Since the wavelength range of the light emitted from a light emitting diode is not so narrow as the wavelength range for the excitation of a rare earth complex, all the light emitted from the light emitting diode is not used for the excitation Accordingly, a light emitting device made by combining a light emitting diode and (a matrix of) a rare earth complex material according to the present invention emits light which is a mixture of the light from the light emitting diode and the fluorescent light of the rare earth complex

Another object of the present invention is to utilize such a light emitting device for the above-described white LED with high color rendering property, and for the purpose europium (Eu) is used as the rare earth element. The structural formulas of the above complexes when Eu is used is as follows:

structural formula (Ie):

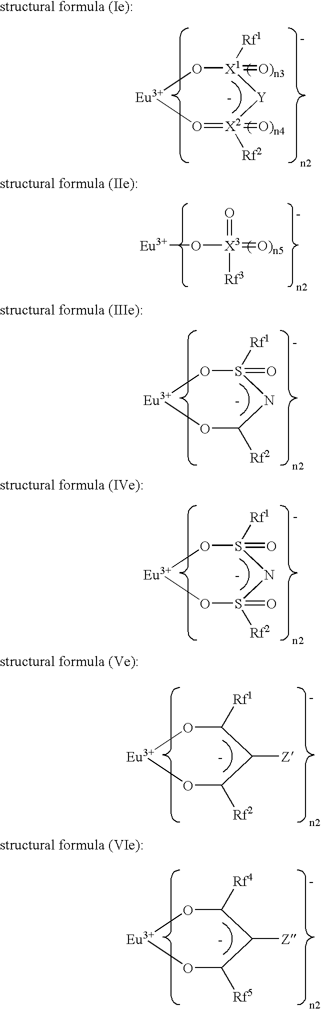

(wherein Rf1, Rf2 and so on are the same as described in the above general formulas (I) to (VI)).

Eu is an element of atomic number 63 and belongs to the lanthanoids. By appropriately selecting ligands, the trivalent ion Eu³⁺ can have the excitation energy for f-f transition at approximately 394, 420 and 465 nm wavelengths (all are blue light), and the emission energy near 600-700 nm wavelengths (red light). Among them, excitation at 394 nm wavelength yields a particularly high emission efficiency. It is a matter of course for a specific value of a wavelength (for example, “394 nm”) cited in the present specification (including claims) to have a certain range around the exact value due to its physical characteristics, or to measurement technologies. In the case where, for example, a wavelength refers to the wavelength of the excitation light of a rare earth complex, its range is as narrow as 1 nm or less irrespective of the types of ligands from the physical and chemical viewpoint But the range may broaden to several nanometers when the measurement technology and the like are taken into account. Further, an emission of a fluorescent light may include many transitions between a number of levels, so that the width of the wavelength range of the emitted fluorescent light may be 10 nm or more.

On the other hand, a nitride semiconductor LED or semiconductor laser represented by a general formula: InₓGa₁₋ₓN (0<x<1) can be made to emit light of an arbitrary wavelength in the blue to ultraviolet region by controlling the value of the component variant x, and the value of the component variant x for generating the excitation light at approximately 394, 420, and 465 nm wavelengths is approximately 0.1 to 0.5 when an Eu complex is used as the rare earth complex.

A mixture of blue light from a light emitting diode and red light from an Eu complex is obtained by combing the above rare earth complex and light emitting diode. A mixture of blue light from a light emitting diode, yellow light from a Y phosphor and red light from an Eu complex is obtained by adding the Y phosphor to the above combination.

FIGS. 3 and 4 show the spectrum of the emitted light and the excitation spectrum of an Eu(Pms)₃ complex (Pms=perfluorophenylmethane) having the above structural formula (IVe) (provided that Rf1=Rf2=CF₃, n2=3) as an example. As shown in FIG. 3, the spectrum of the emitted light is formed of three bands including 590.8, 611.6 and 697 nm. The intensity ratios between these emitted light bands can be changed by appropriately selecting the host materials of the metal complex. Therefore, it is possible to control the color tone in the range from orange to red. On the other hand, the excitation spectrum in FIG. 4 is composed of absorption bands due to the f-f transitions of Eu³⁺. Since the f-f transitions directly excite Eu³⁺ for light emission, no problem arises concerning the deterioration of ligands and the host material due to excitation of actual carriers. In particular, the excitation peak of 394 nm is a sharp and intensive band. Therefore, a particularly efficient wavelength conversion can be carried out by using an InGaN based semiconductor laser having a narrow width of half maximum of emission band, although a combination with a light emitting diode is also effective. As for an InGaN based laser diode, elements of 390-410 nm band having the light output of 20 mW is currently in practical use, and a high output element of 400 mW or more is reported at an experimental stage. Accordingly, a combination of a high output semiconductor laser that oscillates at 394 nm and an Eu³⁺ complex enables an implementation of an emission of red light with an ultra-high luminance. Such a device is not only useful as an illumination device but has a great impact in the application field of display utilizing laser excitation.

On the other hand, absorption bands in the 340-360 nm range, 370-385 nm range or 460-475 nm range, or background absorption of the other wavelength ranges, are comparatively broad. Therefore, a combination with a light emitting diode is effective. Since, in particular, the absorption band in the 460-475 nm range almost agrees with the band of blue light emitted by InGaN of a currently available white LED, a white light emission spectrum with an enhanced color rendering property in the red region and with a slightly decreased color temperature can be implemented as follows. First, a red fluorescent material is made by appropriately adjusting the concentration of Eu³⁺. Then the red fluorescent material is applied to the white LED, whereby apart of the blue light is converted to red light. This enhances the color rendering property of the white LED.

The wavelength of the emitted light of Eu³⁺ ranges from orange to red, whereas an emission of various colors can be obtained by using ions of other rare earth elements as the central ion M of the rare earth complexes represented by the above general formulas (I) to (VI). For example, Tb³⁺ emits green light (excitation wavelengths: 304 and 280 nm, emission wavelengths: 490, 543, 580 and 620 nm), and Eu²⁺ and Ce³⁺ emit blue light By making the complexes of these ions borne in the above-described transparent solid matrix, and by exciting respective complexes with LEDs adapted to respective ions, light emitting devices of various colors can be manufactured.

### BRIEF DESCRIPTION OF THE DRAWINGS

FIG. 1 is a graph showing the spectrum of a white LED (correlated color temperate: 6500 K) made of a gallium nitride based blue LED to which a YAG phosphor is applied and the spectrum of the standard light D₆₅ (correlated color temperature: 6504 K).

FIG. 2 is a table showing the color rendering indexes of a white LED and of other white light sources.

FIG. 3 is a graph showing the emission spectrum of an Eu(pms)₃ complex.

FIG. 4 is a graph showing the excitation spectrum of the Eu(pms)₃ complex.

FIG. 5 is a graph showing the emission spectrum of an InGaN blue LED covered with polymethylmethacrylate (PMMA) bearing Eu(pms)₃ complex, which emits light having a central wavelength of 394 nm.

FIG. 6 is a graph showing the emission spectrum of an InGaN blue LED covered with polymethylmethacrylate (PMMA) bearing Eu(Pms)₃ complex, which emits light having a central wavelength of 465 nm.

FIG. 7 is a graph showing the emission spectrum of a white LED covered with Eu(pms)₃ complex, wherein the white LED is obtained by covering an InGaN blue LED with a YAG phosphor.

FIG. 8 shows a light emitting device wherein a blue InGaN-LED and a YAG phosphor are sealed in a plastic case containing an Eu complex according to one embodiment of the present invention.

FIGS. 9(a) to 9(c) are schematic configuration diagrams each showing an automobile brake lamp made of a semiconductor laser and a plastic cover containing an Eu complex according to another embodiment of the present invention.

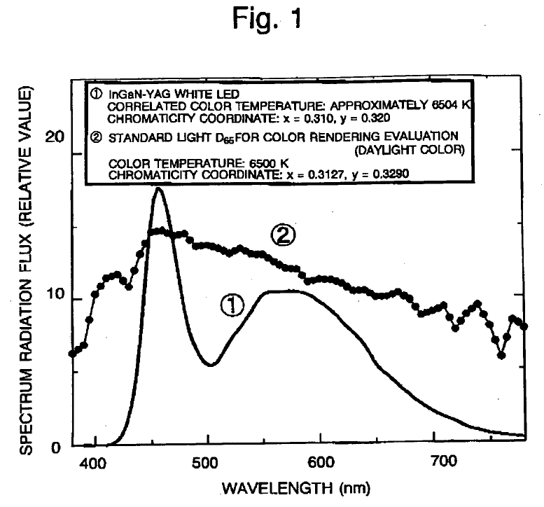

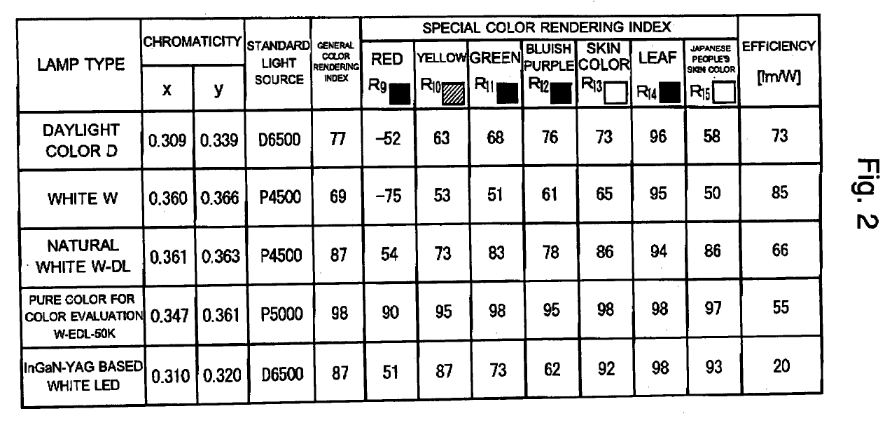

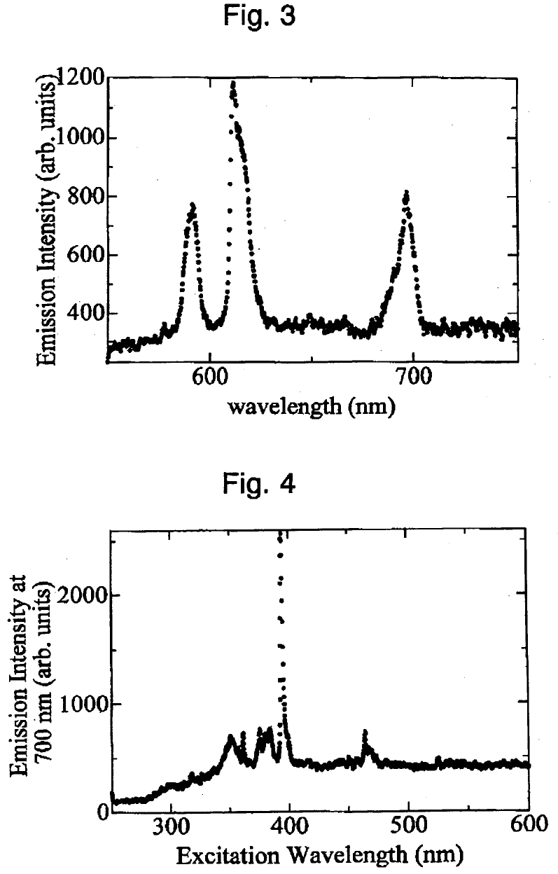

### BEST MODE FOR CARRYING OUT THE INVENTION

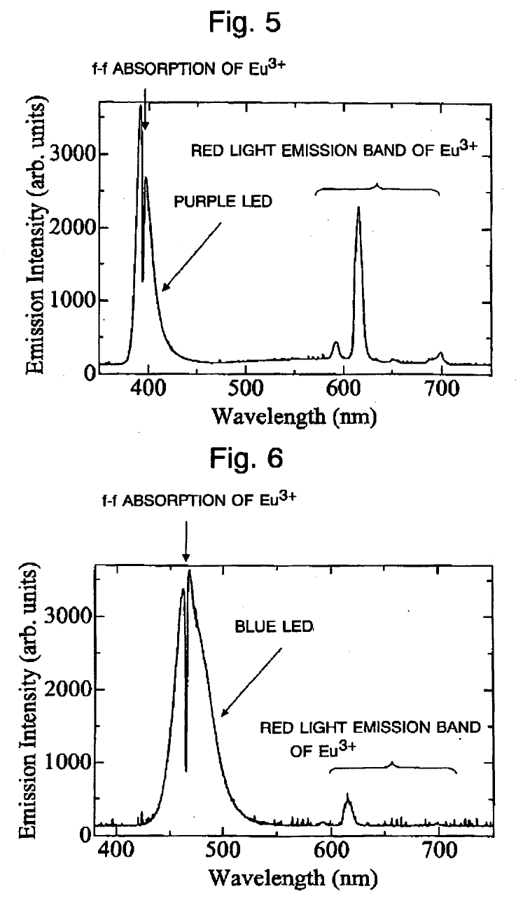

FIG. 5 shows the emission spectrum of an InGaN purple LED covered with polymethylmethacrylate (PMMA) bearing the above Eu(pms)₃ complex. The component variant x of the InGaN-LED is adjusted so that the center of the wavelength of light emitted therefrom becomes 394 nm and, as a result, the LED has a comparatively narrow peak of emission at 390-410 nm range as targeted, wherein a sharp absorption peak appears at 394 nm due to the Eu complex. In addition, a large emission peak appears at 611 nm due to the Eu complex and a small emission peak also appears at around 591 nm. A high emission efficiency of from approximately 50 to 70% is attained in the case where this excitation light is used.

In addition, FIG. 6 shows the emission spectrum of an InGaN-LED of which the component variant x is adjusted so that the emitted light includes 465 nm, which is another excitation wavelength of the Eu complex. A sharp absorption peak of 465 nm due to the Eu complex appears in the peak of the light emitted from the LED in the same manner as described above, and the resultant emission peak appears at around 611 nm, while the peak of 591 nm is hardly noticeable because the efficiency of the light emission by means of this excitation wavelength is not so high.

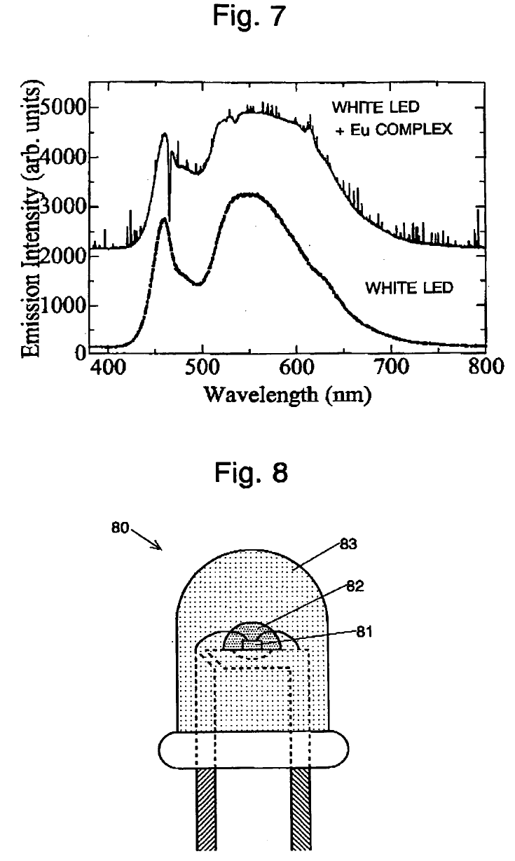

FIG. 7 shows the emission spectrum of a conventional white LED (obtained by covering an InGaN blue LED with a YAG phosphor) covered with the above Eu complex. An absorption peak due to the Eu complex can be clearly noticed at 465 nm. In addition, as a result of this, a relatively m peak of the emitted light becomes noticeable at around 615 nm. As is clear from the sp a light emitting device manufactured in this manner emits light that is almost equal to ideal white light wherein the red component that has been lacking in a conventional white LED is compensated for, and a light source using such a light emitting device becomes a white light source having a very high color rendering property. This can be utilized as a light source which is useful in fields such as those of surgical operation and commercial displays where color recognition and color rendering property are particularly required. That is, the light emitting device according to the present invention can be applied to the field of illumination for medical purposes, the field of illumination in museums, restaurants and the like, as well as the field of indoor illumination for private residences.

It is preferable for a concrete form of this light emitting device to have the same form as a conventional white LED light emitting device in a bullet form as shown in FIG. 8. The conventional white LED light emitting device in a bullet form is obtained by covering an InGaN-LED 81 with a YAG phosphor 82 which is sealed in an epoxy resin package 83 in a bullet form, wherein package 83 in a bullet form protects the LED and, in addition, functions as a lens that condenses light emitted from the LED (through the YAG phosphor). A light emitting device 80 is obtained as one embodiment of the present invention by mixing the above Eu complex into this package resin 83. The light emitting device according to the present invention has the same form as the conventional light emitting device as described above, and thereby conventional white LED illumination devices that have been used at various places can be replaced with light emitting devices according to the present invention and without necessitating any additional changes, so that a great economic saving can be achieved as a result of asset inheritance.

Next, the above rare earth complex can be combined with a semiconductor laser so as to obtain a light emitting device having characteristics differing from the above light emitting device. Light emitted from semiconductor lasers has an extremely narrow wavelength range. Accordingly, the entirety of light from a semiconductor laser can be converted to light having a different wavelength by making the wavelength of light emitted from the semiconductor laser agree with the excitation wavelength of the above rare earth complex, and thereby a light emitting device that solely emits light from the rare earth complex can be obtained.

The features of this light emitting device are as follows: the above rare earth complexes can be borne or included by a variety of resins and the like; and the excitation means is a semiconductor laser which is compact and light in weight. This leads to a broad application range for the purpose of practical use. An example can be considered such that a light emitting device is utilized for a brake lamp of an automobile.

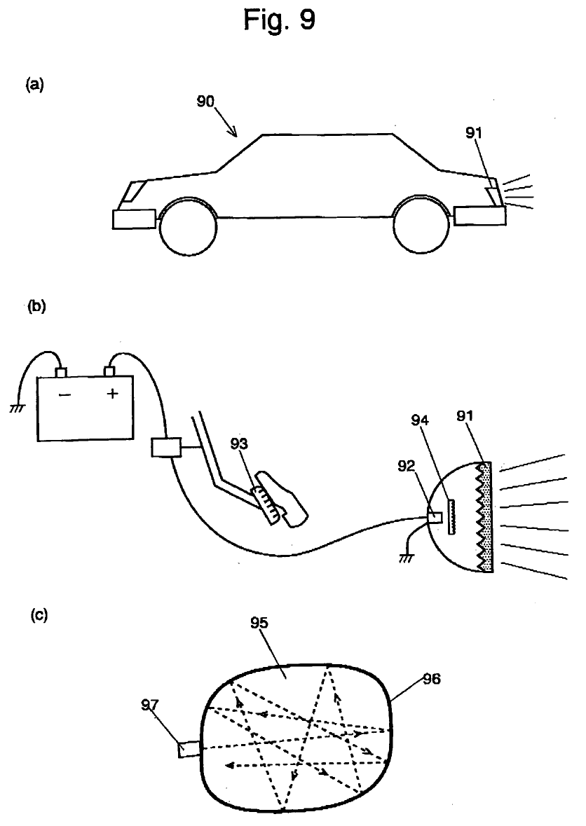

As shown in FIG. 9, a plastic cover 91 (also referred to as a lens) that bears the above rare earth complex is provided in a rear portion (in the case of a brake lamp) of an automobile 90, and a semiconductor laser 92 that emits light including the same wavelength as the excitation light for the rare earth complex is placed behind the plastic cover. Thus, the cover appears to be transparent or white plastic when a brake 93 is not stepped on, while the semiconductor laser 92 emits light of which the wavelength is converted by the plastic cover 91 so that red light is emitted from the rear of the auto mobile 90 when the brake 93 is stepped on. Herein, a diffuser 94 for diffusing a laser beam is provided in the front of the semiconductor laser 92.

A more compact brake lamp can also be considered As shown in FIG. 9(c), the periphery of a plastic cover plate 95 which includes the above rare earth complex is surrounded by reflective walls 96, and a semiconductor laser 97 is attached to a point on the periphery so that the laser beam is emitted diagonally in the plane of the plastic cover 95. Thus, the laser beam is repeatedly reflected by the surrounding reflective walls 96, and its wavelength is converted by the rare earth complex included in the plastic cover 95, so that red light (in case where other rare earth complexes are used, light of corresponding color such as blue or green) is emitted from the surface of the plastic cover 95. If light should be emitted solely from the rear, as in the case of a brake lamp of an automobile, it is desirable to provide reflective plates on the other side. In the case a sign board or indicator on a door, light may be emitted from both sides.

Although one application example for the light emitting device according to the present invention is described above, its applications are not limited to the above described example alone. It is possible to utilize the light emitting device for, for example, a decorative panel installed in a store, for a backlight or a sidelight of a liquid crystal display device of a personal computer, a PDA, a cellular phone and the like. In addition to these it is possible to provide a variety of application examples within the spirit and the scope of the present invention.

1. A light emitting device, wherein a transparent solid matrix that includes one or more kinds of a group of rare earth complexes having the following structural formulas is combined with a light emitting diode or a semiconductor laser for emitting excitation light that corresponds to f-f transition of the central ions of these complexes,
general formula (I): 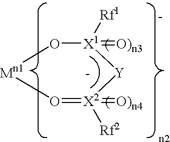
(wherein M represents a rare earth atom; n1 represents 2 or 3; n2 represents 2, 3 or 4; Rf¹ and Rf² are the same or different and represent an aliphatic substituent of C₁ to C₂₂ including no hydrogen atom, an aromatic substituent including no hydrogen atom or a heterocyclic substituent including no hydrogen atom; X¹ and X² are the same or different and represent any atom of the group IVA elements, the group VA elements except nitrogen and the group VIA elements except oxygen; N3 and n4 represent 0 or 1; and Y represents C-Z′ (Z′ represents an aliphatic substituent of C₁ to C₂₂ including no deuterium atom, halogen atom or hydrogen atom), N, P, As, Sb or Bi, provided that n3 is 0 when X¹ is a carbon atom, n4 is 0 when X² is a carbon atom, and at least one of Rf¹ and Rf² is an aromatic substituent including no hydrogen atom when both X¹ and X² are simultaneously carbon atoms),
general formula (II): 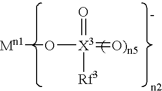
(wherein M, n1 and n2 are as defined in the above; Rf³ represents an aliphatic substituent of C₁ to C₂₂ including no hydrogen atom, an aromatic substituent including no hydrogen atom or a heterocyclic substituent including no hydrogen atom; X³ represents any atom of the group IVA elements except carbon, the group VA elements except nitrogen and the group VIA elements except oxygen; and n5 represents 0 or 1),
general formula (III): 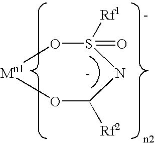
(wherein M, Rf¹, Rf², n1 and n2 are as defined in the above),
general formula (IV): 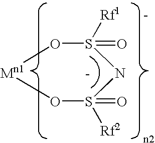
(wherein M, Rf¹, Rf², n1 and n2 are as defined in the above),
general formula (V): 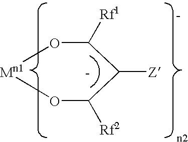
(wherein M, Rf¹, Rf², n1, n2 and Z′ are as defined in the above), and
general formula (VI): 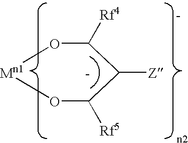
(wherein M, n1 and n2 are as defined in the above; Z″ represents a hydrogen atom or Z′ (Z′ is as described above); and Rf⁴ and Rf⁵ are the same or different and represent an aliphatic substituent of C₁ to C₂₂ including no hydrogen atom, an aromatic substituent including no hydrogen atom or a heterocyclic substituent including no hydrogen atom).

2. The light emitting device according to claim 1, wherein the central ion is Eu³⁺.

3. The light emitting device according to claim 1, wherein the central ion is Tb³⁺.

4. The light emitting device according to claim 1, wherein the central ion is Eu²⁺.

5. The light emitting device according to claim 1, wherein the central ion is Ce³⁺.

6. The light emitting device according to any one of claims 1 to 5, wherein the light emitting diode or the semiconductor laser has a light emitting layer represented by a general formula: InₓGa₁₋ₓN (0<x<1).

7. The light emitting device according to any one of claims 2 to 6, wherein the excitation wavelength of the rare earth complex is 394 ran, and the emission speck of the light emitting diode or the semiconductor laser includes a peak at approximately 394 nm.

8. The light emitting device according to any one of claims 2 to 7, wherein a YAG phosphor is added to the above combination.

9. The light emitting device according to any one of claims 1 to 8, wherein the transparent solid matrix is transparent resin.

10. The light emitting device according to any one of clams 1 to 9, wherein the transparent solid matrix includes a (host-guest) composite that bears the complex having the average particle size of nanometers.

11. An illumination device according to any one of claims 1 to 10, wherein the plural light emitting diodes are arrayed two-dimensionally in a plane.

12. An automobile brake lamp using the light emitting device according to any one of claims 1 to 10.

13. A decorative panel using the light emitting device according to any one of claims 1 to 10.

14. A liquid crystal display device using the light emitting device according to any one of claims 1 to 10 as a backlight or a sidelight.
